(19) United States
(12) Patent Application Publication
(10) Pub. No.: US 2009/0030767 A1
(43) Pub. Date: Jan. 29, 2009

(54) SCHEDULING AND IMPROVING ERGONOMIC BREAKS USING ENVIRONMENTAL INFORMATION

(75) Inventors: Daniel Scott Morris, Bellevue, WA (US); Alice Jane Bernheim Brush, Bellevue, WA (US); Brian R. Meyers, Issaquah, WA (US); Mary P. Czerwinski, Woodinville, WA (US)

Correspondence Address: MICROSOFT CORPORATION;C/O LYON & HARR, LLP, 300 ESPLANADE DRIVE, SUITE 800, OXNARD, CA, 93036, US

(73) Assignee: Microsoft Corporation, Redmond, WA (US)

(21) Appl. No.: 11/782,408

(22) Filed: Jul. 24, 2007

(51) Int. Cl. G06F 9/46; G06F 15/02

(52) U.S. Cl. 705/9

(57) ABSTRACT

An ergonomic break system and method for scheduling and improving an ergonomic break for a user from a computing device. The system and method schedule the break based on environmental information to minimize annoyance to the user. Environmental information includes the condition of the computing device (such as whether the user is typing at the keyboard or using a mouse), the condition of the environment in the immediate vicinity of the computing device (such as whether the user is on the telephone or has another person in the room with her), and the condition of the user (such as whether the user is looking at the display device or is properly stretching during the ergonomic break). The system and method also include features that improve the user's productivity during the break and improve the effectiveness and effectiveness of the break.

### BACKGROUND

As the number of individuals using computers for extended periods of time rapidly increases, repetitive strain injuries (RSI) and ergonomics concerns have become significant public health issues. RSI is expected to become a common problem for the current generation of children and teenagers as they enter the workplace. For many of this generation, computer use has been a daily activity since early childhood. These individuals have not only been subject to more long-term damage than older computer users due to a lifetime of computer use, but are combining full days of office computer work with home computer use, which renders them more susceptible to RSI. As more attention is focused on ergonomics incorporating ergonomics-related features into software environments will be critical as both a solution to a major health problem and a marketing feature in all computer software.

Currently, computer software typically is not designed around ergonomics. Over the next few years, however, ergonomics is predicted to become a business issue, as software manufacturers incorporate ergonomic features into their software. In fact, it is conceivable that in the future software will be rated based its ergonomics and that consumers will make software purchases based on ergonomics. One analogy can be made to automobiles: in the past safety features were not an issue in the marketing of cars, but today safety features are a prime consideration when buying a car. Similarly, in the future ergonomics is predicted to become a prime consideration when buying software.

Ergonomic computer hardware (such as ergonomic keyboards) is currently available, but only limited software mechanisms exist for managing ergonomics. The most popular type of ergonomic software is “break-reminder” software. The ergonomic benefits of taking periodic breaks from typing on a keyboard and using a mouse are both powerful and well-documented. Break-reminder software encourages ergonomic breaks by reminding a user to take short breaks and stretch his hands at regular intervals. In addition, break-reminder software may provide an option whereby the keyboard and mouse are disabled during the break.

One problem, however, with current break-reminder software is that despite the proven benefits of taking regular breaks, such break-reminder software is rarely adopted by users. This is due to the high overhead of introducing periodic interruptions into a user's workflow. In particular, current break-reminder software tends to interrupt user productivity. For this reason users frequently ignore their break reminders or even go as far as turning off this software shortly after installing it. Moreover, a user who is not already experiencing symptoms of RSI or other types of ergonomic injury is unlikely to even install such software.

Another problem is that current break-reminder software is mainly reactive and not preventative. In other words, the user installs the software only because she already has a problem and not because she wants to prevent a future problem. It is unlikely that a user would put this software on her computer if she did not have RSI or a carpal tunnel problem, since the software can become annoying due to the constant break reminder pop-ups and keyboard lockout. Thus, this software currently is only used in response to a health problem and not as a preventive measure since the annoyance overhead is very high. Even still, users often install break-reminder software because their hands hurt only to turn off the software a short time later because the software becomes annoying.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The ergonomic break system and method include using environmental information to schedule and improve ergonomic breaks of a user. Environmental information includes conditions of the user, the computing device that is being used by the user, and the area immediately surrounding the computing device and user (such as the user's office). The system and method build upon the traditional “break reminder” theme but offers ergonomic interactions during the breaks by leveraging alternative input devices and passive document viewing. In this way the system and method improve ergonomics in a user's computing environment by making ergonomic breaks less annoying, more effective, and more productive.

The ergonomic break system and method schedule breaks based on the environmental information to schedule breaks. This “smart scheduling” of ergonomic breaks uses the environmental information to schedule ergonomic breaks at times that will be least invasive to the user. Breaks are scheduled using information that includes a user's digital calendar, whether the user is on the telephone or has another person in the room, application and document reading usage, and whether the user is checking e-mail. Break scheduling can also be based on a user's history of accepting or rejecting breaks at certain times, such that the scheduling of breaks improves over time.

The system and method also use social interaction and “peer pressure” to encourage the taking of breaks and good ergonomic habits. The system and method include a collaborative break that is a video-conferencing activity that allows users to talk and collaboratively stretch during breaks. A user provides a list of other users with whom he is interested in sharing his breaks (a “break buddy” list). Collaborative breaks with these users are initiated automatically when the system and method determine that a break is due. The system and method also coordinate scheduling of collaborative breaks and the notification of participants.

Notification of a user of an impending break also can be based on environmental information. For example, if the system and method determine that the user is involved in a presentation or has another person in the room with her, then the notification of a break can be more subtle than normal. Instead of a pop-up that notifies the user of a break, the system and method could use an indicator that changes color when the user is in a meeting or giving a presentation.

The system and method also have several features that improve the productivity of a user during the break and improve the effectiveness of the break. External sensors can be used to improve productivity during ergonomic breaks. This is done by allowing limited interaction with a computing device during otherwise unproductive breaks. This enables the user to be productive during ergonomic breaks even though he may not be as productive as he would be using a mouse and keyboard. One productivity task that is particularly well-suited for ergonomic breaks is document reading, which primarily requires passive viewing and periodic vertical scrolling. The system and method allow a user to defer document-reading tasks until their ergonomic breaks.

An alternate input device can be used to select documents for later reading, read the documents during the break, or both. For example, foot-based reading and selecting among documents can be performed using a foot-based accelerometer mounted on the user's foot. When the user is viewing content between breaks, within his Web browser he can queue a document for later reading using a graphical user interface button or using a foot-based gesture that is recognized by a browser plug-in. The user may tilt his foot up or down to scroll vertically within the current document, kick his foot forward or back to activate the next and previous documents, or kick his foot to the side to indicate that he is finished with a document (a “kick” is classified as a brief movement along a particular axis that exceeds a threshold acceleration). In addition, a vision-based hand scrolling feature may be used to browse documents. This vision-based hand scrolling feature is discussed in detail below. Since breaks are often too short for a user to read a complete document, the current document and scroll position within that document persist across breaks, and documents are only removed from the queue when the user explicitly indicates completion.

The system and method also identify tasks that are suitable to alternative input mechanisms. In addition, the system and method can suggest using an alternate input device even when the user is not taking a break. This typically occurs when the system and method determine that the user does not need to be using a keyboard or mouse.

Sensors can also be used to improve the effectiveness of ergonomic breaks by sensing and enforcing stretching and body movement of the user during breaks. A significant shortcoming of existing break-reminder software is that it is difficult to enforce or encourage active stretching during ergonomic breaks. Many users eager to continue with their work will fail to move around during a short break and will maintain a tense posture, thus minimizing the break's effectiveness. A user also can select among several types of break activities to improve the effectiveness of the break. These activities include playing ergonomic games (either alone or with break buddies), passively watching short videos, and using an alternate input device to interact with the computing device that does not use the keyboard or mouse.

It should be noted that alternative embodiments are possible, and that steps and elements discussed herein may be changed, added, or eliminated, depending on the particular embodiment. These alternative embodiments include alternative steps and alternative elements that may be used, and structural changes that may be made, without departing from the scope of the invention.

### DRAWINGS DESCRIPTION

Referring now to the drawings in which like reference numbers represent corresponding parts throughout:

FIG. 1 is a block diagram illustrating the ergonomic break system and method disclosed herein implemented in an ergonomic break environment.

FIG. 2 is a block diagram illustrating an exemplary implementation of the ergonomic break system shown in FIG. 1.

FIG. 3 is a flow diagram illustrating the general operation of the method used in the ergonomic break system shown in FIGS. 1 and 2.

FIG. 4 is a flow diagram illustrating the detailed operation of the scheduling module shown in FIG. 2.

FIG. 5 is a flow diagram illustrating the detailed operation of the notification module shown in FIG. 2.

FIG. 6 is a flow diagram illustrating the detailed operation of the productivity improvement module shown in FIG. 2.

FIG. 7 is an exemplary embodiment of a document-browsing user interface of the ergonomic break system shown in FIG. 1.

FIG. 8 is an enlarged view of the insert of the document-browsing user interface shown in FIG. 7.

FIG. 9 is a flow diagram illustrating the detailed operation of the effectiveness improvement module shown in FIG. 2.

FIG. 10 illustrates an example of a suitable computing system environment in which the ergonomic break system and method shown in FIGS. 1-9 may be implemented.

### DETAILED DESCRIPTION

In the following description of the ergonomic break system and method reference is made to the accompanying drawings, which form a part thereof, and in which is shown by way of illustration a specific example whereby the ergonomic break system and method may be practiced. It is to be understood that other embodiments may be utilized and structural changes may be made without departing from the scope of the claimed subject matter.

### I. System and Operational Overview

In general, the ergonomic break system and method disclosed herein configure an ergonomic break for a user by using environmental information to schedule, notify, and improve productivity of the break. In some embodiments, a twenty-second break is scheduled every five minutes, and a five-minute break is scheduled every hour. In other embodiments, the scheduling will depend on a particular user's health needs. Shorter, more frequent breaks (such as, for example, breaks having a duration of about twenty seconds) are called “micro-breaks”, while longer and less-frequent breaks (typically five to ten minutes in duration) are called “rest breaks.” The ergonomic break system and method focus primarily on micro-breaks since most users to either leave their desks or do non-computer-based work during their rest breaks. In other embodiments, various time values are used that can be tailored to a particular user, since ideal values vary significantly from user to user.

In some embodiments the system and method lock out keyboard and mouse input during an ergonomic break. The system and method support “activities” during the ergonomic breaks. In some embodiments, an “activity” is a software module intended to run for the duration of a break, with no keyboard or mouse input. The system and method allow the user to configure the activity-selection mechanism according to the user's preferences. When a break is scheduled to begin, the system and method lock out the keyboard and mouse (if configured to do so) and provide display resources to the selected activity. Additional notifications are provided to the current activity shortly before a break is scheduled to begin and at the end of a break.

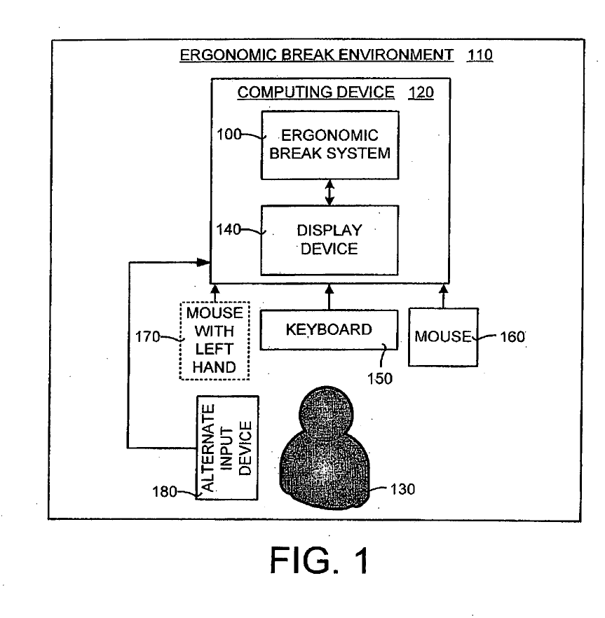

FIG. 1 is a block diagram illustrating the ergonomic break system and method disclosed herein implemented in an ergonomic break environment. It should be noted that the implementation shown in FIG. 1 is only one of many implementations that are possible. Referring to FIG. 1, the ergonomic break system 100 is shown in an ergonomic break environment 110. The environment 110 typically is a room or office where a computing device 120 is located. The ergonomic break system 100 resides on the computing device 120. It should be noted that the computing device 120 may include a single processor (such as a desktop or laptop computer) or several processors and computers connected to each other. A user 130 of the computing device 120 is also part of the ergonomic break environment 110.

The computing device 120 includes a number of output and input devices for the user 130 to interact with the computing device 120. In particular, a display device 140 is connected to the computing device 120 and displays visual information from the computing device 120 to the user 130. Input devices to the computing device 120 include a keyboard 150, and a mouse 160. Note that the mouse 160 typically is on the user's right side. In addition, the mouse 160 may be placed on the user's left side, such that the user 130 operates the mouse 160 with his left hand 170. The dotted box 170 is meant to indicate that the mouse is being operated by the user's left hand instead of the user's right hand. An alternate input device 180 is also connected to the computing device 120 for allowing the user 130 to input data and commands into the computing device 120 without using the mouse 160. The alternate input device 180 is discussed in more detail below.

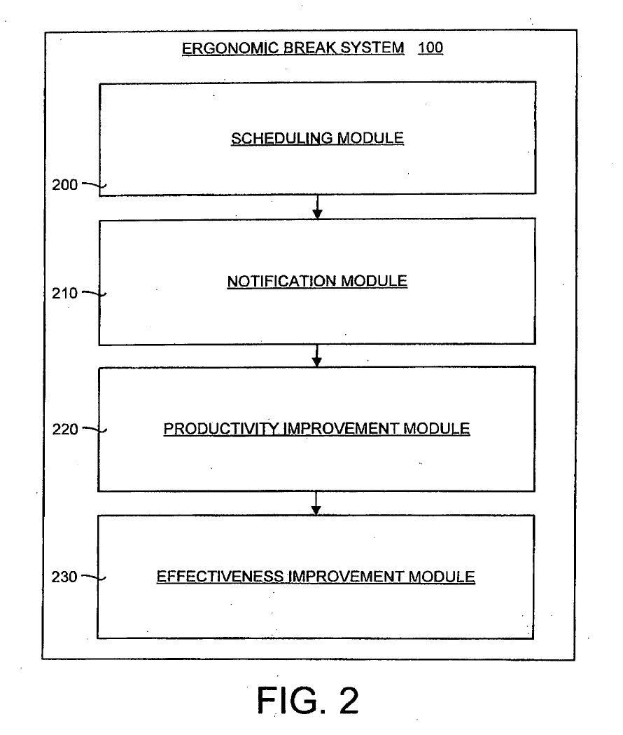

The ergonomic break system 100 is used to schedule and improve ergonomic breaks for the user 130. FIG. 2 is a block diagram illustrating an exemplary implementation of the ergonomic break system 100 shown in FIG. 1. The system 100 includes a scheduling module 200, a notification module 210, and a productivity improvement module 220. In general, the scheduling module 200 uses environmental information to schedule a time and duration of an ergonomic break for the user 130. The notification module 210 uses the environmental information to influence how the user 130 is notified of an ergonomic break. The productivity improvement module 220 uses a variety of features to improve the ergonomic effectiveness and the productivity of the ergonomic break.

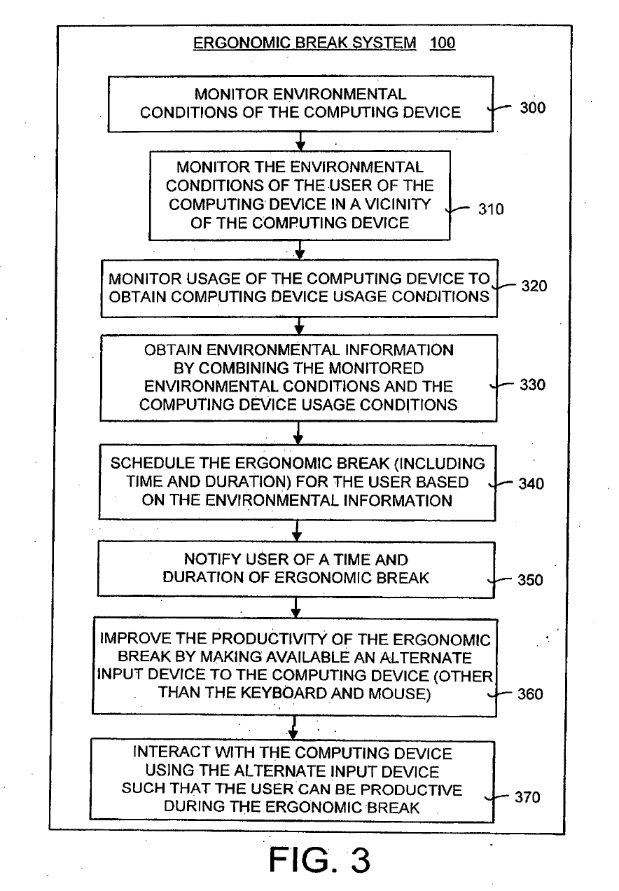

FIG. 3 is a flow diagram illustrating the general operation of the method used in the ergonomic break system shown in FIGS. 1 and 2. The method of the system 100 begins by monitoring environmental conditions of the computing device (box 300). Next, the system 100 monitors the environmental conditions of the user of the computing device in a vicinity of the computing device (box 310). In addition, the usage of the computing device 120 is monitored to obtain computing device usage conditions (box 320).

Environmental information is obtained by combining the monitored environmental conditions and the computing device usage conditions (box 330). Thus, environmental information includes the condition of the computing device 120 or computing device usage conditions (such as whether the user is typing at the keyboard 150 or using a mouse), the condition of the environment surrounding or in the immediate vicinity of the computing device 120 (such as whether the user 130 is on the telephone or has another person in the room with her), and the condition of the user 130 (such as is the user 130 looking at the display device 140 or is the user 130 properly stretching during the ergonomic break). An ergonomic break is scheduled for the user 130 based on this environmental information (340). It should be noted that some or all of the available environmental information may be used. Scheduling the break includes scheduling the time and the duration of the break using the environmental information. Next, the user 130 is notified of the time and duration of the ergonomic break (box 350). During the ergonomic break, the system 100 improves the productivity of the ergonomic break by making available an alternate input device 180 to the computing device 120 (box 360). As stated above, the alternate input device 180 is an input device other than the keyboard 150 and the mouse 160. The user 130 interacts with the computing device during the ergonomic break using the alternate input device 180, such that the user 130 can be more productive during the ergonomic break (box 370).

### II. Operational Details

Each of the modules mentioned above will now be discussed in further detail. In particular, details of the scheduling module 200, the notification module 210, and the productivity improvement module 220 will be discussed to further clarify the details of the ergonomic break system 100 and method.

### Improved Scheduling of Ergonomic Breaks

Current “break reminder” software is fairly naïve in its scheduling of breaks. Existing break-reminder software monitors a user's keyboard and mouse activity to avoid suggesting a break when the user 130 is already resting or when the user 130 is not at her desk. However, this current break-reminder software incorporates no other information into break scheduling. A user will often skip her ergonomic breaks because she feels it should be obvious that she is 2 minutes away from finishing a document or that she is about to leave for a meeting in another building in 4 minutes. The remainder of this section describes features and mechanisms used by the ergonomic break system and method to improve scheduling of breaks so that they will less frequently occur at inopportune times. These features and mechanisms make it more likely that users will actually take their ergonomic breaks when they do come up.

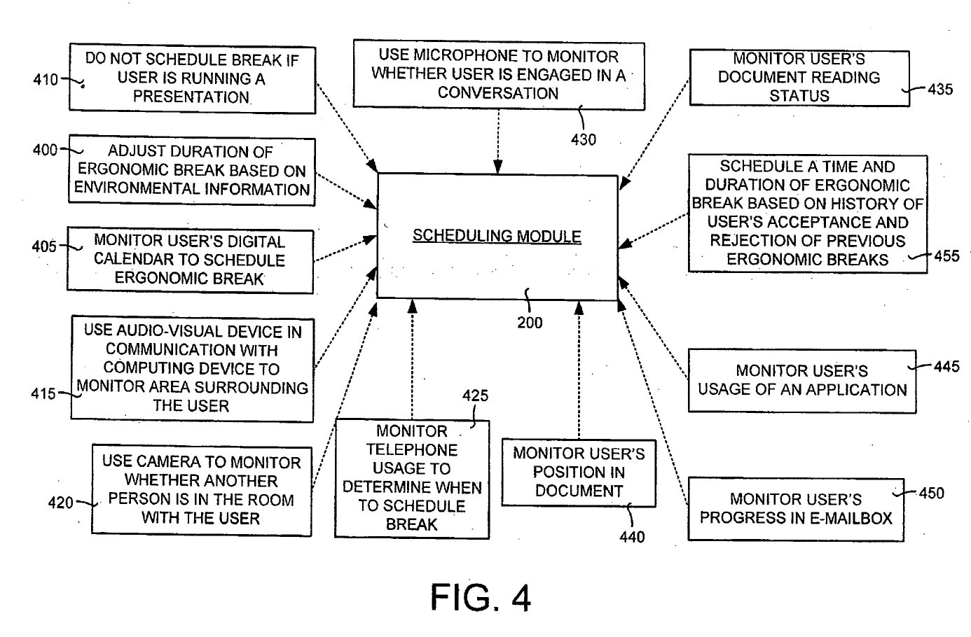

FIG. 4 is a flow diagram illustrating the detailed operation of the scheduling module 200 shown in FIG. 2. In general, the module 200 adjusts the duration of an ergonomic break based on the environmental information (box 400). The module 200 has several features are used to identify good and bad times to schedule an ergonomic break. These features include monitoring the computing device 120 and application usage. In other words, the module 200 examines what is occurring in the user's computer to determine whether it is a good time to schedule an ergonomic break.

The module 200 also includes some flexibility in determining when to schedule a break. Existing break-reminder software typically schedules a break every n minutes and is fairly inflexible about deviation from this schedule. The module 200 has the flexibility to defer breaks if “right now” is inconvenient. This offers some flexibility to the standard “take a break every n minutes” scheduling paradigm and allows breaks to be deferred until a convenient time. For example, if a user 130 wants to take a micro-break every ten minutes, the module 200 may mark a break as “pending” when ten minutes have gone by, at which point the module 200 would start looking for a convenient break time. However, in some embodiments the module 200 puts a limit on just how long it will defer a break to be more convenient. For example, if five more minutes have gone by and no good time has come up, the module 200 might schedule a break anyway, depending on the user's preferences.

### Deferring Breaks Based on Environmental Information

One feature the module 200 can use in the scheduling of breaks is to monitor the user's personal digital calendar to schedule an ergonomic break (box 405). By way of example, the module 200 can monitor the user's Outlook® calendar. If the user 130 is just several minutes away from an appointment away from his office, the module 200 can defer the ergonomic break. If the user 130 is currently scheduled for an appointment in his office (according to his calendar) or the user is currently in a meeting, the module 200 may defer scheduling a break. Moreover, the module 200 typically will not schedule a break if the user 130 is running a presentation (such as a Powerpoint® presentation) on the computing device (box 410).

The module 200 may also use external sensors to monitor the environment of the user 130. This environmental information can supply information about whether now is a good or a bad time for a break. One feature that uses external sensors is to use an audio-visual device (such as a camera) that is in communication with the computing device 120 to monitor the area surrounding the user 130 (box 415). If audio or video data indicate that another person is in the user's office, then the module 200 does not schedule a break. Visual data includes using a camera to monitor whether another person is in the room with the user 130 (box 420). Audio data include monitoring usage of the telephone in the room where the computing device 120 and user 130 are located (such as the user's office) to determine when to schedule a break (box 425). If the user 130 is on the telephone, the module 200 will not schedule a break because the user 130 may be referring to data on the computing device 120. Audio data can also include using a microphone to monitor whether the user 130 is engaged in a conversation within the environment, such as in the user's office (box 430).

### Predicting a Good Time for a Break

The module 200 may also monitor the user's application use to predict times at which the user 130 will be finished with a task or when the user 130 closes an application. In other words, when the user 130 is finished with a task typically is a good time for an ergonomic break. One feature of the module 200 includes monitoring a user's reading status of a document displayed on the display device 140 of the computing device 120 (box 435). The module 200 includes monitoring a user's position in the document (box 440). If the user's primary task is reading document or web page, which is detected as linearly moving through a large document by scrolling or using the keyboard), the module 200 defers a pending ergonomic break until the user 130 reaches the end of the document. Moreover, the module 200 can monitor a user's usage of an application, such as a word processing application (box 445). If the user 130 has been using one application or a fixed set of applications for a long period of time and he closes that application or set of applications, the module 200 assumes that the user 130 has finished a task and thus may schedule a pending ergonomic break before the user 130 starts another task. If the user's primary task is making revisions to a document (which is detected as editing an existing document), and the user 130 is moving continuously forward in the document, when the user 130 reaches the end of the document the module 200 assumes that the user 130 has finished revising the document. At this time the module 200 may suggest a break.

The module 200 may also monitor a user's e-mail usage to determine a good time for an ergonomic break (box 450). If the user's primary task is reading or responding to new e-mail, and the user 130 appears to be moving linearly through his e-mail box, the module 200 may schedule a break when the user 130 has handled the last new e-mail. In other words, a good time to schedule a break is when the user 130 has completed an e-mail task.

### Examining Prior Behavior to Determine a Good Time for a Break

The module 200 can also schedule a time and a duration of an ergonomic break based on a history of the user's acceptance and rejection of previous ergonomic breaks (box 455). Using this history improves future scheduling of breaks. The module 200 can learn over time what types of breaks the user 130 was likely to take and what types of breaks the user 130 was likely to skip. In some embodiments, a machine-learning system can be used to predict (based on current desktop activity), whether the user 130 will accept a break at a given time, given previous instances of accepted and rejected breaks. With a machine-learning system the module 200 can learn over time the conditions and times under which a particular user 130 accepts or rejects ergonomic breaks. The module 200 can skip break reminders that will likely only annoy the user 130. In addition, the module 200 can schedule breaks early when the probability of the user 130 accepting the break is particularly high.

### Other Ways of Scheduling a Break

Instead of formally scheduling an ergonomic break, the module 200 may gently suggest to the user 130 that a particular activity may be conducted in a more ergonomic manner. By way of example, as described below, the module 200 can identify tasks that are suitable for alternative (or non-keyboard or mouse) input. In some embodiments, if all the user 130 is doing is scrolling (or using page up or page down) and there is no editing or typing going on, the module 200 will schedule a break. Moreover, the module 200 can have the user 130 make use of the alternative input device 180 to perform the task currently occurring. In other embodiments the module 200 can suggest speech input (using voice instead of keyboard or mouse). For example, this may occur when the user 130 is performing an imprecise text-centric task (such as instant messaging). In still other embodiments, the module 200 determines that the user 130 has been using a mouse for a prolonged period time, and suggests that the user 130 switch to another type of input device, such as a touchpad or another mouse for use with the opposite mouse hand currently being used.

### Notifying a User of Ergonomic Breaks

The ergonomic break system and method also include a notification module 210. One problem with existing break reminder software is that annoying warnings can pop up when a user is involved in a demonstration or presentation. The module 210 uses different levels of notification to notify the user that it is break time. The general idea of the notification module 210 is that the module alters the way it notifies the user that it is break time based on environmental information. This means that the module 210 can change its notification means based on what is going on in the user's environment at the time.

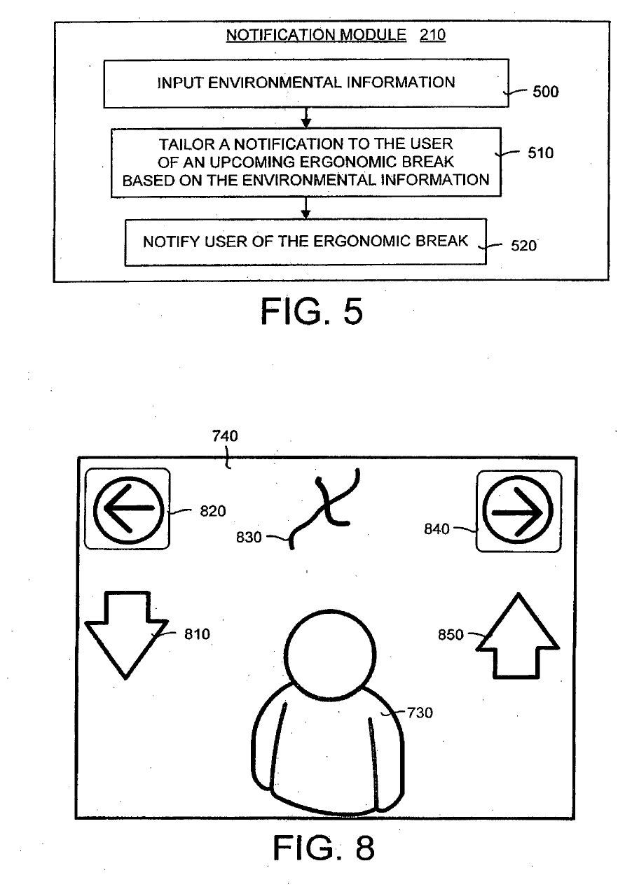

FIG. 5 is a flow diagram illustrating the detailed operation of the notification module 210 shown in FIG. 2. The module 210 initially inputs the environmental information (box 510). As noted above, this environmental information includes computing device usage and the conditions of the environment around the computing device 120. Next, the module 210 tailors a notification to the user of an upcoming ergonomic break based on the environmental information (box 510). For example, assume that someone is in the room with the user because the user is giving a presentation. The module 210 would determine this fact from the environmental information, and then would realize that a discrete notification needs to be sent to the user. In some embodiments, this discrete notification is an indicator that changes color. For example, the indicator could turn from green to red giving a subtle indicator to the user 130 that it is break time.

### Improving Productivity During Ergonomic Breaks

In addition to the mechanisms described above for sophisticated scheduling of breaks, the ergonomic break system 100 also offers alternative content during breaks as well. These are additional types of breaks improve the effectiveness of break by encouraging the user 130 to take the breaks because they allow the user to be more productive than normal ergonomic breaks, are more fun than normal breaks (such as collaborative breaks and interactive and ergonomic game breaks), or they allow high-quality ergonomic stretching to be done during the break. Improving productivity during breaks will be discussed in this section, while the latter two points will be discussed in the next section.

One reason that many users skip recommended ergonomic breaks or uninstall or disable break-reminder software is the productivity interruption that comes with each ergonomic break. In other words, the user feels like she is essentially wasting time and cannot get any work done during those ergonomic breaks. The ergonomic break system and method improve the productivity of a user during her ergonomic breaks. Even though this productivity does not match the user's productivity when she is using a mouse and keyboard, being at least a little productive increase the likelihood that the user will take ergonomic breaks. The productivity improvement module 220 uses an alternate input device 180 to perform a subset of productivity tasks during ergonomic breaks. It should be noted that the alternate input device 180 is designed not to impose RSI-inducing strain on the user. In addition, the alternate input device 180 does not necessarily need to only be used during breaks, but can be used at anytime the user 130 desires. In fact, an additional benefit is that this approach may allow the user 130 to become more comfortable with the alternative input device and may ultimately be ergonomically preferable to the keyboard 150 and the mouse 160 as the primary input device.

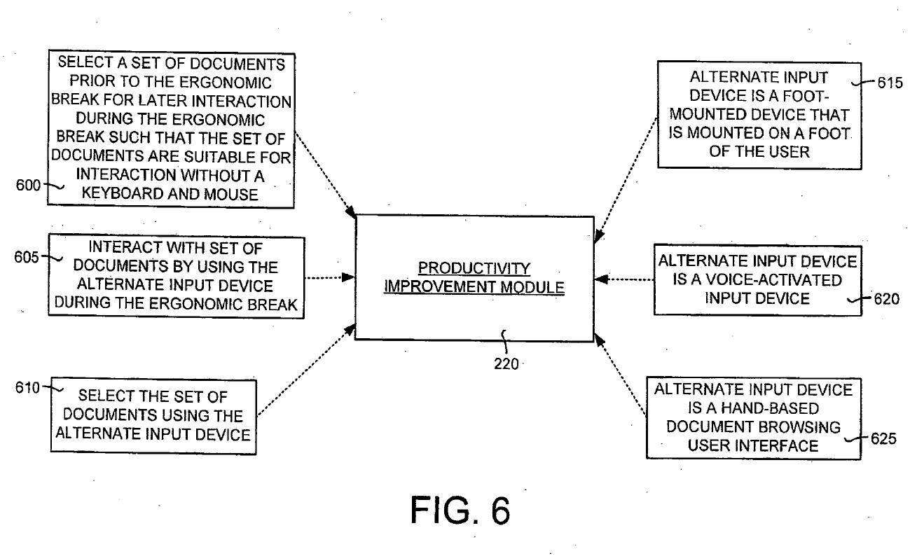

FIG. 6 is a flow diagram illustrating the detailed operation of the productivity improvement module 220 shown in FIG. 2. Part of the challenge in allowing the user to be productive during breaks is that only certain tasks will approach their normal level of speed and usability without the use of a keyboard or mouse. One such task that can be performed without a keyboard and mouse is document reading. Thus, it would be helpful for the user 130 to have several such document reading tasks “queued up” before the ergonomic break begins.

One feature of the module 220 that improves productivity during ergonomic breaks is to select a set of documents prior to the ergonomic break for later interaction during the ergonomic break (box 600). The set of documents is suitable for interaction without the keyboard 150 or the mouse 160. When the user 130 begins an ergonomic break, the set of documents will immediately become available, requiring no awkward navigation that would be difficult without a mouse and keyboard. The user 130 then can scroll through the set of documents and toggle among these documents with just a few simple gestures or speech commands. The set of documents becomes invisible at the end of the break, whereby the user's non-break work context is immediately restored. This minimizes the disruptiveness of having alternative documents appear temporarily.

Another feature of the module 220 that improves productivity during breaks is that it allows the user 130 to interact with the set of documents by using the alternate input device 180 (box 605). In some embodiments, the user 130 can perform many gestures with other parts of his body, such as his feet. Thus, the alternate input device 180 can be sensors on the floor or a wireless sensor mounted on the user's foot. In some embodiments, the user 130 wears a wireless accelerometer on his foot. This allows the user to, for example, scroll a document without the use of the keyboard 150 or mouse 160.

In some embodiments the set of documents is selected by the user using the alternate input device 180 (box 610). In alternate embodiments the set of documents is selected using keyboard 150 or the mouse 160. In some embodiments the alternate input device 180 is a foot-mounted device that is mounted on the foot of the user 130 (box 615). In another embodiment the alternate input device 180 is a voice-activated device (box 620). The module 220 collects the set of documents is in one place that is accessible by the user 130 without the keyboard 150 or the mouse 160. During the break a user interface (UI) appears that has the set of documents the cued up and the user can navigate the set of documents with the alternate input device 180 (such as the foot device). This allows the user 130 to scroll, switch among documents, or close the documents, all without using the keyboard 150 or the mouse 160.

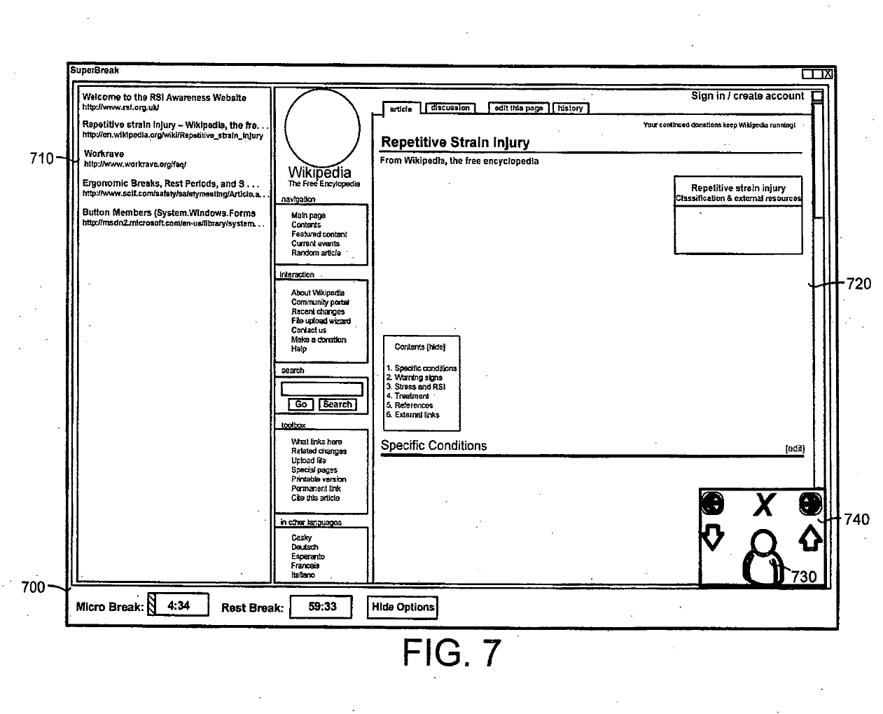

In addition, in some embodiments the alternate input device 180 is the user's hand. This is accomplished using a hand-based document-browsing user interface (box 625). FIG. 7 is an exemplary embodiment of a document-browsing user interface 700 of the ergonomic break system shown in FIG. 1. The document-browsing user interface 700 displays a set of available documents 710 and the current document 720. An interface user 730 is provided with a live image of himself in an insert 740 over which icons are superimposed.

FIG. 8 is an enlarged view of the insert 740 of the document-browsing user interface 700 shown in FIG. 7. The interface user 730 can use his hands to activate any of the superimposed icons. Specifically, by moving his hand to the appropriate location, the interface user 730 can activate a “scroll down” icon 810, a “select previous document” icon 820, and a “delete current document” icon 830. Moreover, the interface user 730 can activate with his hand a “select next document” icon 840, and a “scroll up” icon 850.

In addition, the module 220 uses the alternate input device 180 to provide a way for the user 130 to interact with the computing device 120 without using the keyboard 150 or the mouse 160. In some embodiments, the alternate input device 180 is a wireless or floor-mounted sensor operated by the foot or feet of the user 130. This alternate input device 180 can be used to sense gestures that enable the user 130 to perform a subset of productivity tasks. For example, in some embodiments floor-mounted buttons are used to achieve several discrete inputs. A wireless accelerometer provides sensing for tilt and movement, and is mounted on a shoe or shoes of the user 130 to sense simple foot-based gestures. Some embodiments include the following gestures. First, “kicking” rapidly with one or two feet can be used to emulate discrete clicks or keystrokes. Second, tilting the foot back or forward (which is a flexion or an extension of the ankle) can be used to emulate scrolling. This allows the user 130 to scroll through a document by tilting his foot, and to switch among documents in the set of documents (such as Web pages open in tabs, Microsoft® Word documents currently open, or all open applications) by using a quick “kicking motion”. Other embodiments recognize additional gestures such as movements of both feet independently. For example, a user 130 moving his feet away from each other might mean “open this e-mail”, while moving his feet toward each other might mean “delete this e-mail”.

In some embodiments a camera mounted under a desk where the user 130 is seated is used to achieve the same effect without instrumenting the user at all (or at least minimally instrumenting the user). This camera makes use of the same gestures described in the previously, but can recognize foot position by background subtraction or by other mechanisms. Background subtraction, which is well known by those of ordinary skill in the art, is particularly effective given the fairly predictable environment of the user's foot on a floor. This camera can be a typical Webcam or an infrared (IR) camera suited for recognizing reflective markers placed on the user's shoe. In still other embodiments, the alternate input device 180 is a microphone. In these embodiments, speech recognition is used and is automatically activated during the ergonomic break. This allows the user 130 to perform normal typing and mouse tasks (albeit at a possibly reduced rate).

### Improving Effectiveness of Ergonomic Breaks

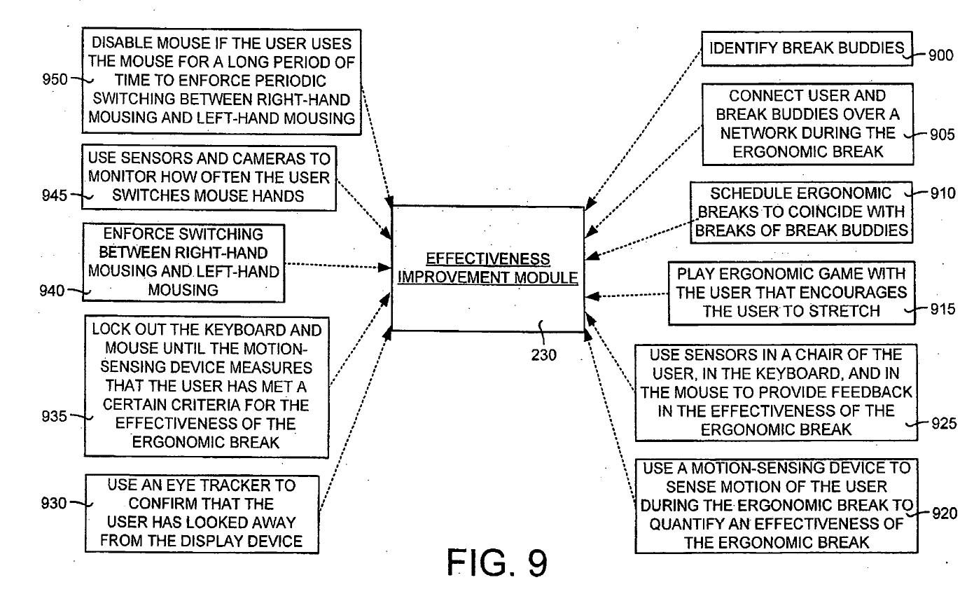

As stated above, in addition improving the productivity of the ergonomic break, there are additional types of alternative content during breaks offered by the ergonomic break system 100. FIG. 9 is a flow diagram illustrating the detailed operation of the effectiveness improvement module 230 shown in FIG. 2. In particular, the module 230 includes features and mechanisms that improve the effectiveness of breaks by encouraging the user 130 to take the breaks because they are more fun than normal breaks (such as collaborative breaks and interactive and ergonomic game breaks), or they allow high-quality ergonomic stretching to be done during the break. Each of the features of the module 230 now will be discussed in detail.

### Collaborative Breaks

One example of a type of alternate break is a break that emphasizes peer-to-peer communication, or a collaborative break. Collaborative breaks involve more than one user taking ergonomic breaks together. These types of breaks use social or peer pressure to encourage a user to take breaks. The ergonomic break system and method leverage social pressures to help users resist the temptations to skip ergonomic breaks. In addition, taking a break with another person makes breaks more fun and enjoyable. Thus, collaborative breaks encourage users to actually take their breaks. One way in which the module 230 schedules collaborative breaks is to identify break buddies (box 900). In some embodiments, a break buddy list is an explicitly-provided list of other users with whom a user would like to talk to during collaborative breaks. In an alternate embodiments, the break buddy list is an implicit list of users with whom a user would like to take collaborative breaks. For example, the an implicit break buddy list may be an instant messenger (IM) list or an e-mail contacts list. In still other embodiments, the break buddy list is a list of all registered “collaborative break-takers”, either a public list or a list administered within an organization.

The module 230 can connect the user and his break buddies over a network during the ergonomic break (box 905). In some embodiments, the module 230 sends out an invitation to others on a break buddy list and pops up a video conference with these buddies during the break. Registered users can have a video conference that is immediately initiated when a collaborative ergonomic break is scheduled. In some embodiments the conference ends immediately at the end of the break. The presence of a video channel allows users to urge their partners to stretch and relax their hands. In other embodiments, the module 230 lets the user 130 and his break buddies chat. In yet other embodiments, the module 230 schedules a collaborative game during the ergonomic break such that the element of competition is added to the break. These brief, multi-player games can be based on video input, accelerometers, foot movement sensors, or all of the above. Note that games during the ergonomic break are discussed below.

The module 230 can schedule ergonomic breaks to coincide with the breaks of break buddies (box 910). This can be a particularly difficult task since each user's break-reminder software is subject to certain constraints. When the module 230 determines that it is almost time for an ergonomic break, the module 230 contacts the user's break buddies over the network with “break requests.” Each system receiving a break request may respond with a variety of responses, includes a response that the user is not at his desk or cannot take a break right now, or that the user just took a break so he cannot take another break right now, or that the user can take a break with you in n seconds, but not right now. The response also can be that the user can take a break with you right now. In some embodiments the module 230 allows “fuzzy” scheduling of collaborative breaks such that every user specifies break timing options in approximate ranges. For example, a user might tell the ergonomic break system 100 that he wants a twenty-second break every five minutes, but that once in a while the user 130 is willing to have a break come up anywhere from three to six working minutes after the previous break. In addition, the user 130 may tell the module 230 that he is willing to have that break be anywhere from fifteen to thirty seconds long.

After collecting responses the module 230 may proceed in a variety of ways. First, the module 230 may select one of the respondents to take a break and send a “break initiation” message. This break initiation message states the time and duration of the break and initiates a connection between the two users' computers. For example, the message may say “we are going to take a break together that is n seconds long and will start in t seconds.” In this case, both users are notified of the upcoming break. When the agreed-upon break arrives, the ergonomic break system and method on each end of the connection both take the necessary actions to initiate the break. These actions may involve disabling the mouse and keyboard, initiating a video conference, or acquiring video or audio resources. Alternatively, the module 230 may determine that no respondent can take a collaborative break. In this case the module 230 schedules a non-collaborative (or normal) break instead and informs the user 130. This break may be a typical “just sit and rest” break, or may use the mechanisms and features described below to enhance the break's productivity and effectiveness.

### Ergonomic Games and Activities

The module 230 can improve the effectiveness of ergonomic breaks by allowing the user 130 to play a game that encourages specific types of movement, such as stretching (box 915). In some embodiments the module 230 plays ergonomic games that use a camera to encourage stretching. This makes breaks more fun for the user 130. In other embodiments the module 230 plays a game that puts dots in the corners of the display device 140 and the idea is for the user 130 to reach up and touch those dots with his hands. It is fun and encourages people to stretch. In still other embodiments the module 230 plays a game that encourages the user 130 to move around the room whereby virtual objects are hidden in the room and the module 230 lets the user 130 know whether he is getting closer to the object (such as you're hot, or you're cold).

In some embodiments the module 230 includes a vision-based targeting game that is played during the ergonomic break. Specifically, a standard webcam mounted above the user's display device 140 captures an image of the user 130 at his desk, and presents on-screen targets that the user 130 is required to activate with hand movement. Activation is detected using simple frame-to-frame subtraction. A change image is created by subtracting the intensity at each pixel from that observed in the previous frame. A threshold is applied to determine the set of active pixels, and if a target area contains sufficient active pixels then it is considered a “hit” and the user is rewarded or penalized depending on the set of targets currently displayed. In other embodiments, the module 230 can delay the end of a break until a threshold “score” is achieved, thereby enforcing a certain amount of movement and stretching during a break.

In some embodiments the module 230 also includes an activity for passively viewing videos during breaks. This provides either informative or entertaining content that requires minimal user initiative but still encourages the taking of ergonomic breaks. This activity leverages the growing popularity of the Web as a source of video content to provide a familiar form of passive interaction. In one implementation of this activity, the user 130 is allowed to choose a set of video sources that will be polled daily for a list of available videos (such as youtube.com and grouper.com). The user 130 also has the ability to select among specific categories at each source. Videos are sorted by duration and are optimally matched to break lengths (longer videos tend to contain little content in the first few seconds, which will be all the user sees during a typical micro-break). When this activity is selected for a break the module 230 launches a viewer and directs it to the next video on the list.

### Enforcement to Improve Effectiveness of a Break

Another shortcoming of existing break-reminder software is that it merely prevents a user from typing or using a mouse during a break, and visually suggest that a user stretch her hands and back or do other movements that significantly enhance the benefits of taking breaks. However, many users of existing break-reminder software packages remain hunched over their keyboards during breaks, muscles tensed, anxiously awaiting the opportunity to work again. This does little to relieve muscle strain and does nothing for problems related to posture or seat pressure. The module 230 uses external sensors to enforce stretching and movement during ergonomic breaks and to make these breaks more ergonomically effective. This allows the user 130 to take breaks less often to keep the same level of ergonomic benefit, and thus the user 130 is more likely to take the breaks.

The module 230 provides enforcement of breaks in a variety of ways. One enforcement feature is to have the module 230 give the user 130 feedback about whether she is stretching appropriately. Another feature is to not allow the user's break to end until certain conditions have been met. For example, the module 230 can require and enforce that the user 130 perform a certain set of motions during the break. A camera mounted on top of the display device 140 can be used to determine and confirm that the user 130 is performing suggested stretches. Moreover, the module 230 can use a motion-sensing device to sense motion of the user 130 during the ergonomic break to quantify an effectiveness of the ergonomic break (box 920). Movement sensed by the motion-sensing device can include, for example, monitoring whether the user 130 has in fact stretched his hands by using external sensors. Sensors that can be used to sense appropriate movements include wireless accelerometers to sense hand and foot motion, and using a monitor-mounted camera to sense gross motion or identify specific hand postures. This can confirm that specific stretching exercises have been completed. Moreover, a floor-mounted button or other sensor can be used to confirm that the user 130 has left his chair and walked to a different part of the office. Sensors on the chair or on the floor can be used to encourage the user 130 to get up from her chair and walk around the room and go to another part of her office. Sensors also can be used in the keyboard 150 and the mouse 160 to provide additional feedback on the effectiveness of the ergonomic break (box 925). For example, an infrared or capacitive touch sensor mounted on the keyboard 150 can be used to confirm that the user 130 has in fact removed his hands from the keyboard 150 during his break. In addition, an eye tracker can be used to confirm that the user 130 has looked away from the display device 140 (box 930). This is useful to confirm that the user 130 has moved his eyes around during his break. In certain circumstances eye strain can develop from prolonged computer use, and in these situations enforced “looking away” can be valuable.

The module 230 also can lock out the keyboard 150 or the mouse 160 until the motion-sensing device measures that the user 130 has met certain criteria for the effectiveness of the ergonomic break (box 935). The module 230 can use accelerometers to sense motion of the user's hands, feet, or both. This allows the module 230 to measure whether the user 130 is stretching or has stretched appropriately during the breaks. In some embodiments, this certain criteria includes requiring that the user 130 move in certain ways or move all fours limbs to provide feedback for the effectiveness of the break. In other embodiments, a milder version is to provide the user 130 with a visual indication (such as a bar) of how beneficial and effective the break was, and trust the user 130 to try and maximize the benefit of the break.

Another ergonomic issue is posture. The module 230 can use input from a monitor-mounted camera to estimate the position of the user's head to look for “slouching”. This is particularly helpful since slouching tends to be both gradual and subconscious. The module 230 provides the user 130 with feedback when posture appears to have declined, and can lock the keyboard 150 or the mouse 160 until the user's posture has improved. Accelerometers can be used to detect posture in the user 130. In addition, sensors in clothing of the user 130 can be used to detect posture. The use of cameras, posture sensors (such as a shirt having a flex sensor), and accelerometers to detect posture and allow the module 230 to provide effective feedback and enforcement of the user's posture at the computing device 120.

It is also clear that for users who develop chronic problems related to mouse use, changing the hand with which the user 130 moves the mouse can result in dramatic ergonomic benefits. One way to achieve this is to enforce switching from mousing using the right hand to left-hand mousing (box 940). Sensors and cameras can be used to monitor with which hand the user 130 is using the mouse and how often the user 130 switches hands (box 945). By way of example, in some embodiments capacitive sensors mounted in the mouse 160 can be used to enforce that the user switches mouse hands periodically. In alternate embodiments vision techniques are used to monitor the user's hands to enforce that the user switches mouse hands periodically. In addition, the module 230 can disable a mouse if the user 130 uses a certain mouse for a long period of time (box 950). This enables the module to enforce alternately enable and disable the mouse 160 to enforce hand-switching.

### Suggestions to the User for Improved Break Effectiveness

Instead of enforcing, the module 230 can also provide suggestions to the user 130. For example, if the user is 130 repeatedly scrolling in a document using the mouse or keyboard without having entered any text or having made any revisions, the module 230 can remind the user 130 that this task would be just as easy with the alternate input device 180 suggest the use of an accelerometer or scroll wheel available on the user's desk. Moreover, if the user 130 is typing in an informal setting where dictation errors would likely not be a problem (such as an instant messenger (IM) client or personal e-mail system), the module 230 can suggest the use of a speech recognizer in place of the keyboard 150. In addition, if the user 130 is consistently using the mouse without using the keyboard 150 (such as when browsing the Web), the module 230 can suggest the use of a mouse alternative such as a touchscreen or touchpad.

Some keyboard and mouse actions are ergonomically worse than others. The module 230 can use sensors to identify how often the user 130 performs these actions and, while taking into account how ergonomically bad these actions are, and then schedule breaks based on this information. For example, continuously using the mouse may be ergonomically worse than typing on the keyboard. This means that when the user 130 is continuously using the mouse the module 230 would schedule breaks more frequently than if the user 130 was only typing on the keyboard. Moreover, in other embodiments the module 230 schedules different types of breaks having various durations. The ergonomic factor (or how bad each action is ergonomically) is either preset or the user 130 is allowed to enter the information through a user interface. Thus, the module 230 can schedule a break duration, frequency, and type based on keystroke and mouse usage patterns (or prolonged repetition of one activity) or based on specific input event, such that each type or content of an input event (such as a keyboard, mouse, or scroll wheel input) has a value that represents how ergonomically bad is the input event or action.

### III. Exemplary Operating Environment

The ergonomic break system and method are designed to operate in a computing environment. The following discussion is intended to provide a brief, general description of a suitable computing environment in which the ergonomic break system and method may be implemented.

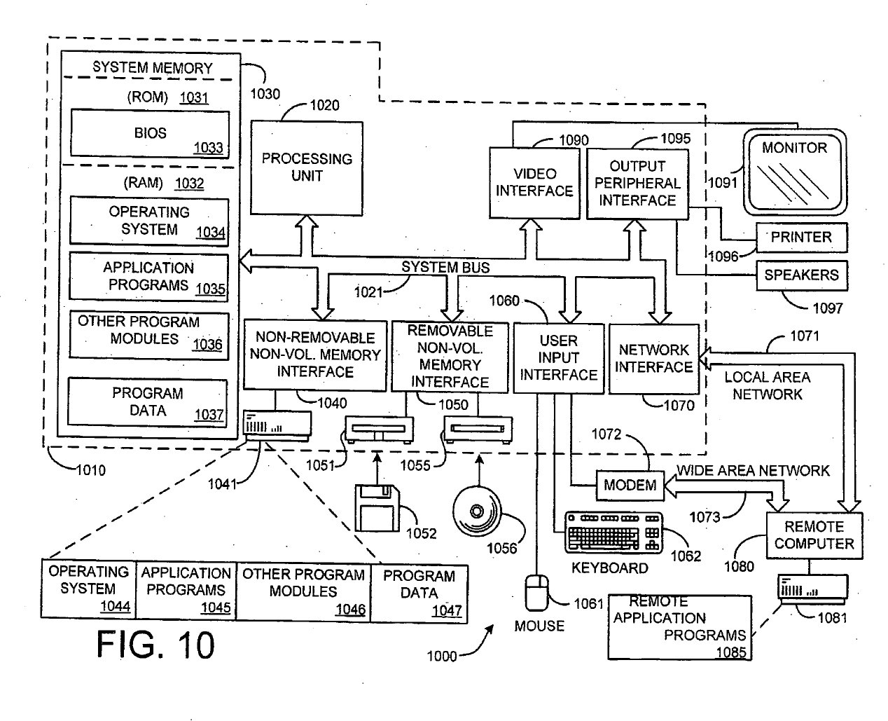

FIG. 10 illustrates an example of a suitable computing system environment in which the ergonomic break system and method shown in FIGS. 1-8 may be implemented. The computing system environment 1000 is only one example of a suitable computing environment and is not intended to suggest any limitation as to the scope of use or functionality of the invention. Neither should the computing environment 1000 be interpreted as having any dependency or requirement relating to any one or combination of components illustrated in the exemplary operating environment.

The ergonomic break level system and method are operational with numerous other general purpose or special purpose computing system environments or configurations. Examples of well known computing systems, environments, and/or configurations that may be suitable for use with the ergonomic break system and method include, but are not limited to, personal computers, server computers, hand-held (including smartphones), laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The ergonomic break system and method may be described in the general context of computer-executable instructions, such as program modules, being executed by a computer. Generally, program modules include routines, programs, objects, components, data structures, etc., that perform particular tasks or implement particular abstract data types. The ergonomic break system and method may also be practiced in distributed computing environments where tasks are performed by remote processing devices that are linked through a communications network. In a distributed computing environment, program modules may be located in both local and remote computer storage media including memory storage devices. With reference to FIG. 10, an exemplary system for the ergonomic break system and method include a general-purpose computing device in the form of a computer 1010 (the computing device 120 is an example of the computer 1010).

Components of the computer 1010 may include, but are not limited to, a processing unit 1020 (such as a central processing unit, CPU), a system memory 1030, and a system bus 1021 that couples various system components including the system memory to the processing unit 1020. The system bus 1021 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 1010 typically includes a variety of computer readable media. Computer readable media can be any available media that can be accessed by the computer 1010 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 1010. Communication media typically embodies computer readable instructions, data structures, program modules or other data in a modulated data signal such as a carrier wave or other transport mechanism and includes any information delivery media.

Note that the term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 1040 includes computer storage media in the form of volatile and/or nonvolatile memory such as read only memory (ROM) 1031 and random access memory (RAM) 1032. A basic input/output system 1033 (BIOS), containing the basic routines that help to transfer information between elements within the computer 1010, such as during start-up, is typically stored in ROM 1031. RAM 1032 typically contains data and/or program modules that are immediately accessible to and/or presently being operated on by processing unit 1020. By way of example, and not limitation, FIG. 10 illustrates operating system 1034, application programs 1035, other program modules 1036, and program data 1037.

The computer 1010 may also include other removable/non-removable, volatile/nonvolatile computer storage media. By way of example only, FIG. 10 illustrates a hard disk drive 1041 that reads from or writes to non-removable, nonvolatile magnetic media, a magnetic disk drive 1051 that reads from or writes to a removable, nonvolatile magnetic disk 1052, and an optical disk drive 1055 that reads from or writes to a removable, nonvolatile optical disk 1056 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1041 is typically connected to the system bus 1021 through a non-removable memory interface such as interface 1040, and magnetic disk drive 1051 and optical disk drive 1055 are typically connected to the system bus 1021 by a removable memory interface, such as interface 1050.

The drives and their associated computer storage media discussed above and illustrated in FIG. 10, provide storage of computer readable instructions, data structures, program modules and other data for the computer 1010. In FIG. 10, for example, hard disk drive 1041 is illustrated as storing operating system 1044, application programs 1045, other program modules 1046, and program data 1047. Note that these components can either be the same as or different from operating system 1034, application programs 1035, other program modules 1036, and program data 1037. Operating system 1044, application programs 1045, other program modules 1046, and program data 1047 are given different numbers here to illustrate that, at a minimum, they are different copies. A user may enter commands and information (or data) into the computer 1010 through input devices such as a keyboard 1062, pointing device 1061, commonly referred to as a mouse, trackball or touch pad, and a touch panel or touch screen (not shown).

Other input devices (not shown) may include a microphone, joystick, game pad, satellite dish, scanner, radio receiver, or a television or broadcast video receiver, or the like. These and other input devices are often connected to the processing unit 1020 through a user input interface 1060 that is coupled to the system bus 1021, but may be connected by other interface and bus structures, such as, for example, a parallel port, game port or a universal serial bus (USB). A monitor 1091 (such as the display device 140 shown in FIG. 1) or other type of display device is also connected to the system bus 1021 via an interface, such as a video interface 1090. In addition to the monitor, computers may also include other peripheral output devices such as speakers 1097 and printer 1096, which may be connected through an output peripheral interface 1095.

The computer 1010 may operate in a networked environment using logical connections to one or more remote computers, such as a remote computer 1080. The remote computer 1080 may be a personal computer, a server, a router, a network PC, a peer device or other common network node, and typically includes many or all of the elements described above relative to the computer 1010, although only a memory storage device 1081 has been illustrated in FIG. 10. The logical connections depicted in FIG. 10 include a local area network (LAN) 1071 and a wide area network (WAN) 1073, but may also include other networks. Such networking environments are commonplace in offices, enterprise-wide computer networks, intranets and the Internet.

When used in a LAN networking environment, the computer 1010 is connected to the LAN 1071 through a network interface or adapter 1070. When used in a WAN networking environment, the computer 1010 typically includes a modem 1072 or other means for establishing communications over the WAN 1073, such as the Internet. The modem 1072, which may be internal or external, may be connected to the system bus 1021 via the user input interface 1060, or other appropriate mechanism. In a networked environment, program modules depicted relative to the computer 1010, or portions thereof, may be stored in the remote memory storage device. By way of example, and not limitation, FIG. 10 illustrates remote application programs 1085 as residing on memory device 1081. It will be appreciated that the network connections shown are exemplary and other means of establishing a communications link between the computers may be used.

The foregoing Detailed Description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A method for scheduling and improving an ergonomic break from a computing device, comprising:
monitoring environmental conditions of the computing device and of a user of the computing device to obtain environmental information;
scheduling the ergonomic break for the user based on the environmental information; and
improving a productivity of the ergonomic break by making available an alternate input device to the computing device for the user to use;
wherein the alternate input device is an input device other than a keyboard and a mouse.

2. The method of claim 1, further comprising tailoring a notification to the user of the ergonomic break based on the environmental information.

3. The method of claim 1, further comprising adjusting a duration of the ergonomic break based on the environmental information.

4. The method of claim 1, further comprising:
allowing the user to select a set of documents prior to the ergonomic break for later interacting during the ergonomic break such that the set of documents are suitable for interaction without a keyboard and mouse; and
interacting with the set of documents by using the alternate input device during the ergonomic break.

5. The method of claim 4, wherein allowing the user to select further comprises having the user use the alternate input device to select the set of documents.

6. The method of claim 5, wherein the alternate input device is at least one of: (a) a foot-mounted input device that is mounted on a foot of the user; (b) a voice-activated input device; (c) a camera coupled to a hand-based document browsing user interface.

7. The method of claim 1, further comprising monitoring a digital calendar of the user to schedule the ergonomic break.

8. The method of claim 1, further comprising using an audio-visual device in communication with the computing device to monitor an area surrounding the user to obtain the environmental information.

9. The method of claim 8, wherein the audio-visual device includes a camera and a microphone, and further comprising:
monitoring whether another person is in a room with the user;
monitoring whether the user is engaged in a conversation; and
scheduling the ergonomic break based on whether another person is in the room with the user and whether the user is engaged in a conversation.

10. The method of claim 1, further comprising using a motion-sensing device to sense motion of the user during the ergonomic break to quantify an effectiveness of the ergonomic break.

11. The method of claim 10, further comprising locking out the keyboard and the mouse of the computing device until the motion-sensing device measures that the user has met a certain criteria for the effectiveness of the ergonomic break.

12. The method of claim 10, further comprising using sensors in a chair of the user, in the keyboard, and in the mouse to provide feedback in the effectiveness of the ergonomic break.

13. The method of claim 1, further comprising having the user play an ergonomic game on the computing device that encourages the user to stretch.

14. The method of claim 13, further comprising:
providing a mouse connected to the computing device;
using a sensors in the mouse to monitor how often the user uses each hand with the mouse; and
disabling the mouse after determining that the user has been using a same hand for a long period of time to operate the mouse to enforce periodic switching between operating the mouse with the user's right and operating the mouse with the user's left hand.

15. A computer-readable medium having computer-executable instructions for scheduling ergonomic breaks from a computing device for a user, comprising:
monitoring usage of the computing device to obtain computing device usage conditions;
monitoring an environment of the user in a vicinity of the computing device to obtain user environment conditions;
combining the computing device usage conditions and the user environment conditions to obtain environmental information;
scheduling a time and duration of the ergonomic break for the user based on the environmental information; and
notifying the user of the time and duration of the ergonomic break.

16. The computer-readable medium of claim 15, further comprising:
monitoring the user's usage of an application on the computing device to obtain application usage conditions;
adding the application usage conditions to the environmental information to obtain updated environmental information; and
scheduling a time and duration of the ergonomic break for the user based on the environmental information.

17. The computer-readable medium of claim 15, further comprising scheduling a time and duration of the ergonomic break for the user based on a history of the user's acceptance and rejection of previous ergonomic breaks.

18. The computer-readable medium of claim 15, further comprising:
identifying another user as a break buddy;
scheduling the ergonomic break to coincide with an ergonomic break of the break buddy; and
connecting the user and the break buddy over a network during the ergonomic break such that the user and the break buddy can interact with each other during the ergonomic break.

19. A computer-implemented process for improving a productivity of a user during the user's ergonomic break from a computing device, comprising:
scheduling the ergonomic break based on environmental information of the user and the computing device;
notifying the user of a time and duration of the ergonomic break;
providing an alternate input device to the computing device for use by the user during the ergonomic break, wherein the alternate input device is an input device other than a keyboard and mouse; and
interacting with the computing device using the alternate input device such that the user can be productive during the ergonomic break.

20. The computer-implemented process of claim 19, further comprising:
selecting documents for inclusion in a list for later viewing during the ergonomic break using the alternate input device prior to the ergonomic break; and
using the alternate input device to interact with the list of selected documents during the ergonomic break.
